(19) United States
(12) Patent Application Publication
(10) Pub. No.: US 2018/0138592 A1
(43) Pub. Date: May 17, 2018

(54) MULTI-BEAM ANTENNA ARRANGEMENT

(71) Applicant: Telefonaktiebolaget LM ERisson (Publ), Stockholm (SE)

(72) Inventors: Anders DERNERYD, Göteborg (SE); Lars MANHOLM, Göteborg (SE)

(21) Appl. No.: 14/896,577

(22) PCT Filed: Jul. 4, 2013
(86) PCT No.: PCT/EP2013/064092

§ 371 Date: Dec. 7, 2015

(51) Int. Cl. H01Q 3/40; H01Q 21/22; H01Q 25/00; H04B 7/08; H01Q 21/08; H01Q 1/52

(52) U.S. Cl. CPC H01Q 3/40; H01Q 21/22; H01Q 1/523; H04B 7/0874; H01Q 21/08; H01Q 25/00

(57) ABSTRACT

A multi beam antenna arrangement has antenna elements arranged to form an antenna array with a first end and an opposite second end, and at least one beam-forming matrix having antenna ports connected to the antenna elements. The antenna arrangement is configured to generate multiple orthogonal antenna beams. The beam-forming matrix comprises at least two antenna ports with a predetermined order and phase relation and a plurality of beam ports. The at least two antenna ports are fewer in number than the plurality of antenna elements. A subgroup of the antenna ports is connected to at least two of the plurality of antenna elements via at least one splitter/combiner arrangement, to enable dividing a power supplied by the antenna port to the at least two antenna elements or by combining a respective power received on the at least two antenna elements.

### TECHNICAL FIELD

The proposed technology generally relates to a multi-beam antenna arrangement and a network node with such an antenna arrangement.

### BACKGROUND

Within the field of communication there are several different technologies used for providing transmitting and receiving antennas for terminals and network nodes. One such technology concerns so called smart antennas. Two of the main types of smart antennas concern so-called switched beam antennas and adaptive array antennas. Switched-beam and multiple-beam antennas can be used in many applications to generate several available fixed beam patterns with high gain, narrow beams in fixed directions in order to suppress interference in a mobile network. In order to provide the multiple beams to and from an antenna array a beam-forming matrix is typically employed. Beam-forming is used to create the radiation pattern of the antenna array by adding constructively the phases of the signals in the direction of the target desired, and nulling the pattern of the targets that are undesired or interfering. In addition, beam forming can be used at both the transmitting and the receiving ends to achieve spatial selectivity. One well-known beam-forming technique is the use of a Butler matrix connected to a linear array antenna. All antenna elements are excited uniformly with different linear phase fronts for each beam port and a number of orthogonal beams are generated with the passive RF network. An N×N Butler matrix has N input ports and N output ports, herein referred to as beam ports and antenna ports. The latter ones are in the current disclosure connected to antenna elements or antenna columns in a planar array. Each beam port generates one beam pattern that is orthogonal to all other beams. An example with a 4×4 Butler matrix and four radiating antenna elements is shown in FIG. 1. The corresponding normalized beam patterns are displayed in FIG. 2. The maximum side-lobe level is about 13 dB below the beam peak. This is inherent with a Butler feed since it generates a set of uniform excitations with different phase settings.

The influence of side lobe levels is typically detrimental to the performance of the multi beam antenna, since they cause interference between the signals received, amongst other things. Therefore, there is a need for solutions enabling reducing the side lobe levels and at the same time maintain the orthogonal beam pattern of the antenna arrangement. Maintaining orthogonal patterns is desirable since orthogonal patterns ensure, and are necessary for, high isolation between the beam ports.

### SUMMARY

It is an object to provide an improved multi beam antenna arrangement.

This and other objects are met by embodiments of the proposed technology.

According to a first aspect, there is provided a multi beam antenna arrangement, comprising a plurality of antenna elements arranged to form an antenna array with a first end and an opposite second end, and at least one beam-forming matrix having a plurality of antenna ports connected to the antenna elements. The antenna arrangement is configured to generate a plurality of orthogonal antenna beams, and the beam-forming matrix comprises at least two antenna ports with a predetermined order and phase relation and a plurality of beam ports. The at least two antenna ports are fewer in number than the plurality of antenna elements. Further, at least one of a subgroup of the antenna ports is connected to at least two of the plurality of antenna elements via at least one splitter/combiner arrangement, to enable dividing a power supplied by the antenna port to the at least two antenna elements or by combining a respective power received on the at least two antenna elements. In addition, the antenna elements are positioned in the antenna array with a corresponding predetermined order and phase relation as the antenna ports to reduce side-lobe levels of the antenna arrangement while maintaining a linear phase gradient over the antenna elements.

According to a second aspect, there is provided a network node that comprises an antenna arrangement described above.

Embodiments of the proposed technology enables/makes it possible to reduce the side lobe levels of multi beam antenna arrangements.

Other advantages will be appreciated when reading the detailed description.

### BRIEF DESCRIPTION OF THE DRAWINGS

The embodiments, together with further objects and advantages thereof, may best be understood by referring to the following description taken together with the accompanying drawings, in which:

FIG. 1 illustrates a prior art antenna arrangement;

FIG. 2 illustrates the beam pattern generated by the arrangement in FIG. 1;

FIG. 3 illustrates an embodiment of the proposed technology;

FIG. 4 illustrates an embodiment of the proposed technology;

FIG. 5 illustrates the beam pattern generated by the embodiment of FIG. 4;

FIG. 6 illustrates an embodiment of the proposed technology;

FIG. 7 illustrates the beam pattern generated by the embodiment of FIG. 6;

FIG. 8 illustrates an embodiment of the proposed technology;

FIG. 9 illustrates the beam pattern generated by the embodiment of FIG. 8;

FIG. 10 illustrates an embodiment of the proposed technology;

FIG. 11 illustrates the beam pattern generated by the embodiment of FIG. 10;

FIG. 12 illustrates an embodiment of the proposed technology;

FIG. 13 illustrates the beam pattern generated by the embodiment of FIG. 12;

FIG. 14 illustrates an embodiment of the proposed technology;

FIG. 15 illustrates the beam pattern generated by the embodiment of FIG. 14;

FIG. 16 illustrates an embodiment of the proposed technology;

FIG. 17 illustrates an embodiment of the proposed technology;

FIG. 18 illustrates an embodiment of the proposed technology;

FIG. 19 illustrates an embodiment of the proposed technology.

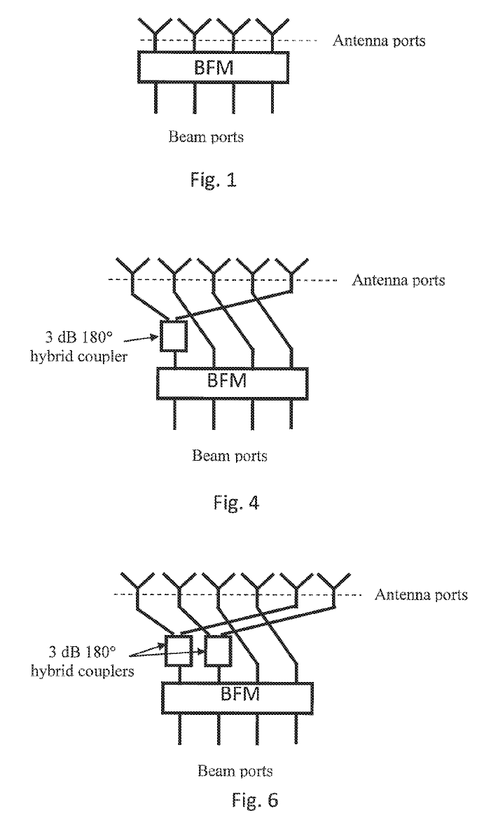

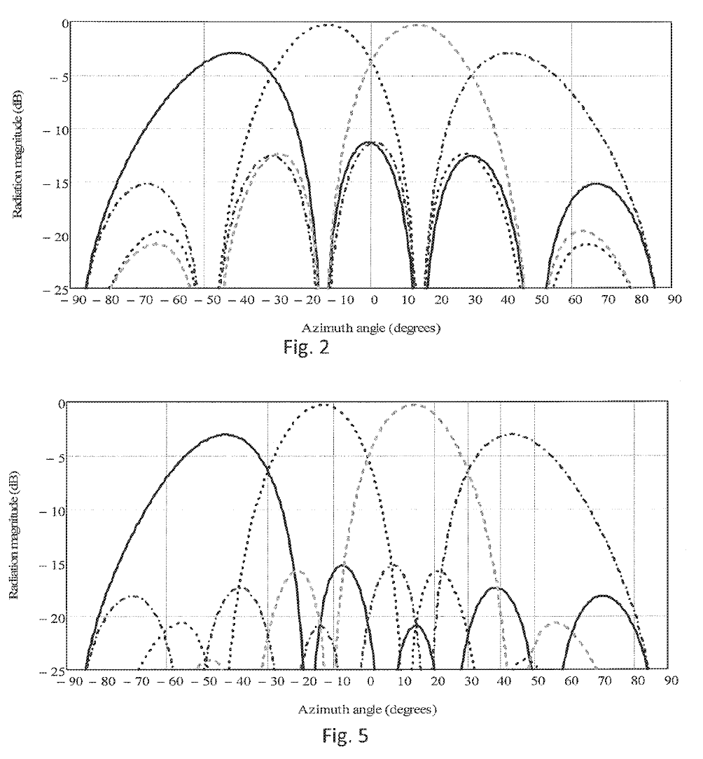

### DETAILED DESCRIPTION

Throughout the drawings, the same reference numbers are used for similar or corresponding elements.

In the following description, mainly beam-forming matrices in the form of Butler matrices will be described. However, the proposed technology is equally applicable to other beam-forming networks, and also to beam-forming in the base band, examples of which will also be described below. The beam-forming matrix can thus comprise a Butler matrix, a Blass matrix or a Rotman matrix, or some other beam-forming matrix, or a beam-forming matrix at the base band.

For a better understanding of the proposed technology, it may be useful to begin with a brief overview of a known solution of reducing the side lobe levels in a multi beam antenna arrangement.

A modified Butler matrix has been proposed to taper the antenna excitation [1-3]. At each antenna port of an N×N Butler matrix, a branch-line hybrid or an un-equal power splitter/divider is attached and thereby splitting/combining the power among twice as many antenna ports. The extra components are not identical in order to generate to a desired amplitude taper. The number of beams and the beam directions remain constant while the number of antenna elements is doubled.

The above-described solution does have a number of disadvantages that the current proposed technology solves. Firstly, the existing solutions are limited to doubling the antenna ports and thereby the number of antenna elements. Secondly, the required additional circuitry is rather complex in order to obtain the amplitude taper. Finally, the additional components are not of identical design, which further complicates the design and implementation of the tapering solution.

Consequently, the inventors have identified a possibility to reduce the side lobe levels with a simplified circuitry compared to the above described prior art. The inventors have proposed, in order to provide the necessary amplitude taper to reduce the side-lobe level in the radiation pattern, to add identical 3 dB 180-degree hybrid couplers or splitters/combiners to a selected number of antenna ports of the Butler matrix. These additional antenna ports are connected to additional antenna elements at the edge of the antenna array to form a non-uniform amplitude taper across the radiating elements while maintaining the linear phase gradient.

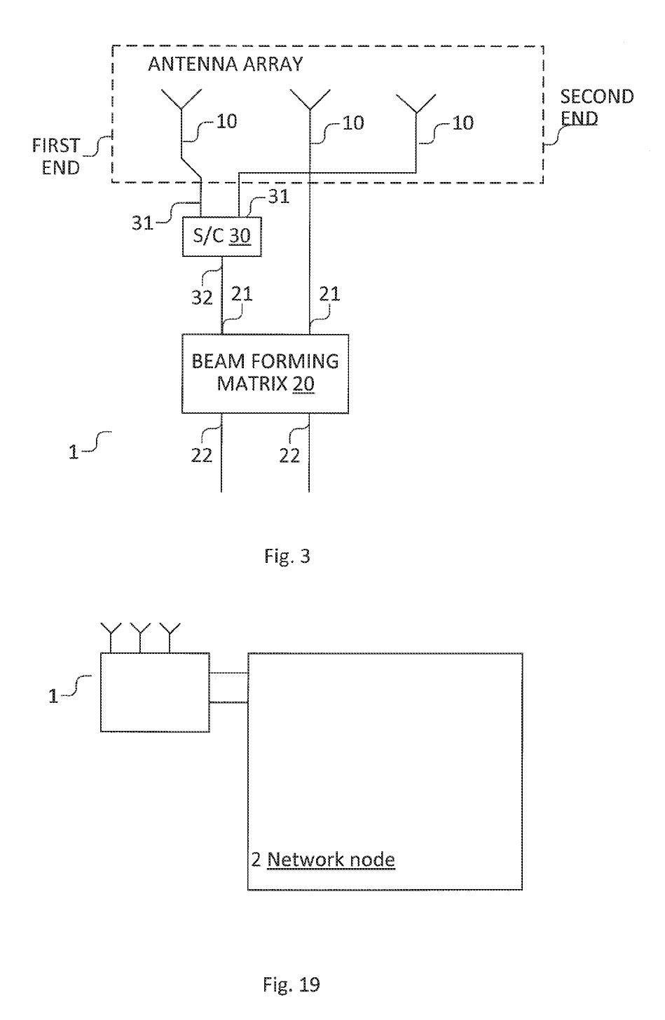

With reference to FIG. 3, a basic embodiment of a multi-beam antenna arrangement with reduced side lobe levels will be described. In this embodiment, the multi-beam antenna arrangement 1 includes a plurality of antenna elements 10 arranged to form an antenna array with a first end and an opposite second end. At least one beam-forming matrix or arrangement 20 with a plurality of antenna ports 21 is connected to the antenna elements 10 and is configured to generate a plurality of orthogonal antenna beams. The beam-forming matrix can comprise a Butler matrix or the like. In particular, the beam-forming matrix 20 comprises at least two antenna ports 21 with a predetermined order and phase relation and a plurality of beam ports 22. The at least two antenna ports 21 are fewer in number than the plurality of antenna elements 10. Further, at least one of a subgroup of the antenna ports 21 is connected to at least two of the plurality of antenna elements 10 via at least one splitter/combiner arrangement 30. Thereby a power supplied by the antenna port 21 to the at least two antenna elements 10 can be divided, or a respective power received on the two antenna elements can be combined at the antenna port. The at least two antenna elements connected to the splitter/combiner are positioned in the antenna array with a corresponding order and phase relation as the antenna ports to reduce the side lobe levels of the antenna arrangement and maintaining a linear phase gradient over the antenna elements 10.

Each splitter/combiner 30 or hybrid coupler 30 comprises at least two first ports 31 connectable to a respective antenna element 10 or to an antenna element 10 and an additional splitter/combiner and at least one second port 32 connected to an antenna port 21 of the beam-forming matrix 20. In addition, depending on the specific application, the splitter/combiner 30 can comprise a splitter/combiner or a hybrid coupler of varying design.

The order and phase relation of the antenna elements can be further described according to the following. If the antenna ports 21 in FIG. 3 are numbered 1, 2 from left to right. Then the antenna elements 10 need to be arranged in a corresponding order 1, 2, 1 in order to preserve the order and phase relation of the antenna ports. In other words, for the basic case of a single splitter/combiner arranged at an edgemost antenna port, the antenna elements connected to the splitter/combiner are arranged at a respective opposite end of the antenna array. However, for a case of multiple splitter/combiners or a splitter/combiner arranged at a antenna port which is distant from either of the first or second opposing ends of the antenna array, the situation becomes more complicated and the arrangement is best described with an order and phase relation of the antenna ports.

The above-described embodiment comprises two antenna ports 21 and three antenna elements 10. However, the current proposed technology is equally applicable to arrangements with a larger number of antenna ports 21 and antenna elements 10, embodiments of which will be further described below.

The antenna arrangement of the proposed technology can, according to one embodiment, comprise a plurality of antenna elements 10 arranged in a linear antenna array. According to another embodiment, each antenna element 10 can comprise a column of antenna elements, thereby rendering a planar antenna array, or more generally, any group of antenna elements constituting what is known as a sub-array.

The reduced side-lobe level in a Butler-fed linear array (or similar beam-forming matrix) according to the proposed technology is achieved by amplitude tapering the antenna element excitations. This is obtained by adding identical or potentially non-identical 3 dB 180 degree hybrid couplers or splitter/combiners at selected antenna ports 21 of a Butler matrix (or similar beam-forming matrix). In an embodiment presented in FIG. 4, a five-element array antenna is connected to a 4×4 Butler matrix. An extra antenna element 10 is thus added at one edge of the linear antenna array and the power to the edge antenna elements of the array antenna is divided equally. An additional 180-degree phase shift is necessary to incorporate in the feeding of the additional edge antenna element in order to maintain the linear phase shift along the array for all beams. This is accomplished with the 3 dB 180-degree hybrid coupler. In a 4×4 Butler matrix with no beam at 0°, the successive antenna port phases are ±45° for the central beams and ±135° for the outer beams as given in Table I.

TABLE I
Phases at antenna ports of a 4x4 Butler matrix with no beam at 0°

| Port number | 1 | 2 | 3 | 4 |
|---|---|---|---|---|
| Central beams | 0° | ±45° | ±90° | ±135° |
| Outer beams | 0° | ±135° | ±270° | °±45° |

In FIG. 5, a normalized beam pattern of the above-described modified Butler-fed five element linear antenna array is shown. The beam directions are maintained and the beam widths are slightly reduced resulting in a slight gain increase. The peak side-lobe level is reduced to −15 dB.

With reference to FIG. 6, a further embodiment of the proposed technology will be described. In this case, two 3 dB 180 degree hybrid couplers are added to selected antenna ports e.g. first and second antenna ports 21 of a 4×4 Butler matrix. In addition, two extra antenna elements are added at the edge of the array antenna. In this context, “extra” is used to indicate that there are more antenna elements than for the normal case of a 4×4 Butler or beam-forming matrix. A circuit diagram is shown in the figure. The normalized radiating beam patterns for the embodiment with the six element linear antenna array are presented in FIG. 7. The beam directions are maintained and the beam widths are further reduced (when compared to the use of a single 3 dB hybrid coupler or splitter/combiner) resulting in a slight gain increase. The peak side-lobe level is reduced to −15 dB.

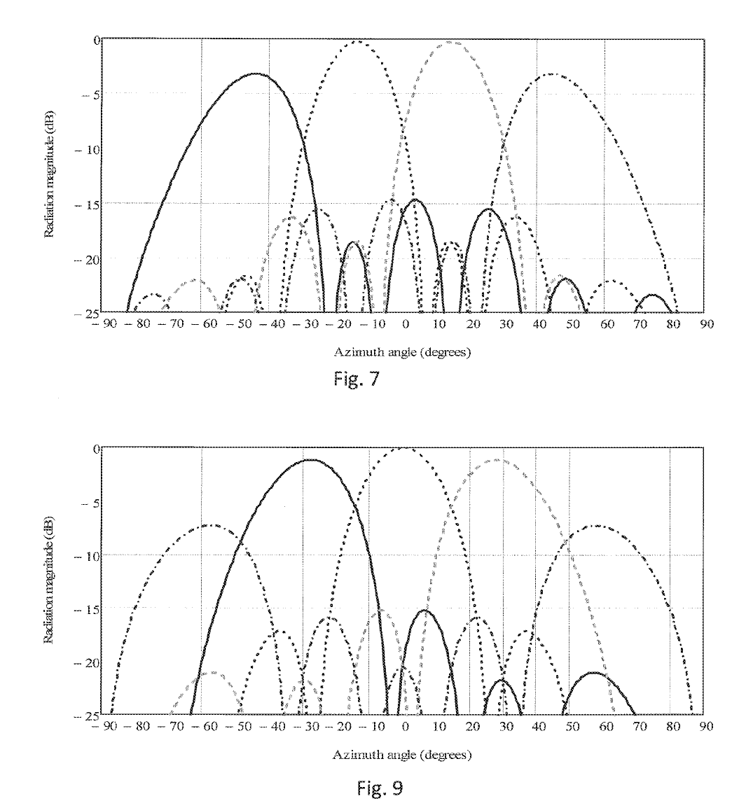

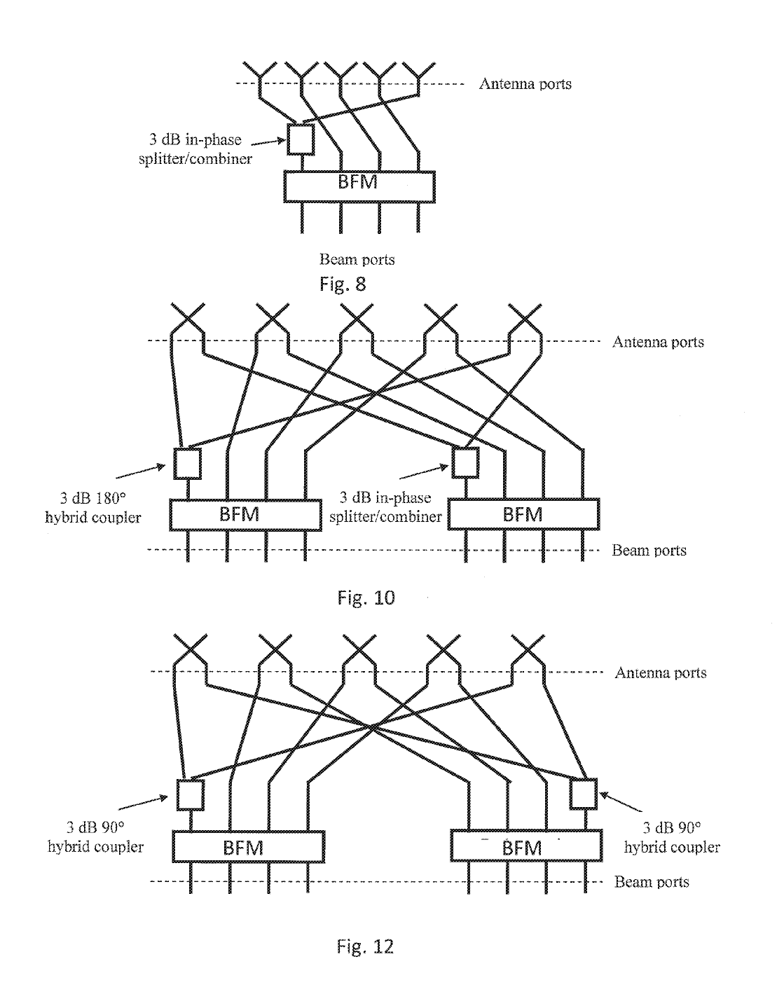

With reference to FIG. 8 a further embodiment will be described. Here one 3 dB in-phase splitter/combiner is added to one selected antenna port of a Butler matrix. The Butler matrix is designed to generate a multi-beam pattern with one beam direction in the normal direction (0°). The successive antenna port phases in this case are 0° for the central beam, ±90° for the intermediate beams and 180° for the outer beam as given in Table II.

TABLE II
Phases at antenna ports of a 4x4 Butler matrix with a beam at 0°

| Port number | 1 | 2 | 3 | 4 |
|---|---|---|---|---|
| Central beam | 0° | 0° | 0° | 0° |
| Intermediate | 0° | ±90° | ±180° | ±270° |
| beams | | | | |
| Outer beam | 0° | ±180° | 0° | ±180° |

One extra antenna element is added at the edge of the array antenna. A circuit diagram is shown in the figure. The normalized radiating beam patterns for the five-element linear array antenna connected to a 4×4 Butler matrix, e.g. beam-forming matrix, are presented in FIG. 9. The beam directions are maintained and the beam widths are reduced resulting in a slight gain increase as compared to a conventional Butler matrix. The peak side-lobe level is reduced to −15 dB.

In the above-described embodiments, each antenna element comprises a single antenna element arranged on a linear antenna array, or possibly a column of antenna elements comprising a planar antenna array. However, it is also possible to use dual polarized antenna elements in order to provide two interleaved beam patterns.

According to yet another embodiment, with reference to FIG. 10, each antenna element 10 can comprise two co-located antenna elements with different polarization i.e. a dual polarized antenna element. In this case, two sets of interleaved antenna beams are generated. Each polarization then has its own beam-forming matrix 20, e.g. the antenna arrangement 1 includes two beam-forming matrixes 20, one for each polarization. In this case the order and phase relations between and within the antenna ports 21 for each polarization needs to be maintained in the order of the antenna elements 10. In FIG. 10, only one splitter/combiner or hybrid coupler for each beam-forming matrix is disclosed. However, the concept can be extended to include multiple splitter/combiners arranged at each beam-forming matrix. In the present disclosure one of the beam-forming matrixes 20 is provided with a 3 dB 180-degree hybrid coupler, whereas the other beam-forming matrix 20 is provided with a 3 dB in-phase splitter/combiner.

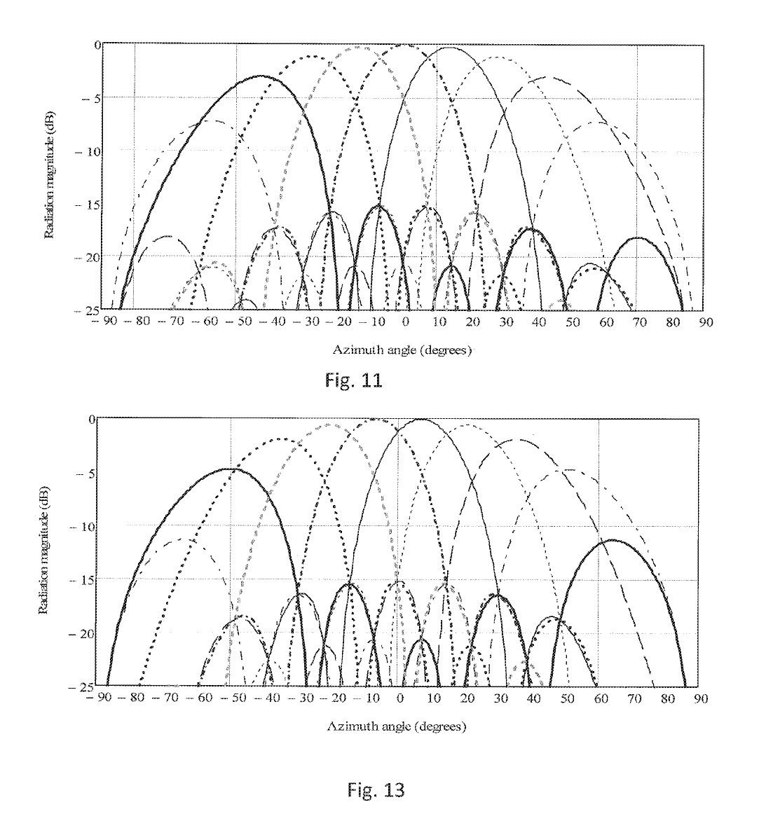

The previously described concept is thus extended to generate two sets of interleaved beams to fill up the gain drop at the beam crossover points between two adjacent beams. The two sets of beams use different polarizations, for example vertical and horizontal or slanted plus and minus 45 degrees. The modified Butler matrixes in FIG. 6 and FIG. 8 are connected to one polarization each of a dual polarized array antenna element 10. The combined multi-beam radiation patterns will then cover a broad sector in angle with two sets of orthogonal beams that are by prior art offset by half an antenna beam-width. An embodiment is displayed in FIG. 10 and the normalized radiation patterns of two sets of interleaved beam patterns of the five-element dual-polarized linear array antenna connected to two 4×4 Butler matrixes are shown in FIG. 11.

With reference to FIG. 12, a further embodiment with the interleaved beams offset is shown and the corresponding radiation patterns are plotted in FIG. 13. The power splitters/combiners are 90-degree hybrid couplers in this case. The successive antenna port phases of the 4×4 Butler matrix in this case are −157.5° for the left most beam, −67.5° for the next beam, 22.5° for the following beam, and 112.5° for the right most beam as given in Table III when the beams are offset in the negative azimuth angle direction. Similar combined performance can be achieved with −90-degree hybrid couplers instead.

TABLE III
Phases at antenna ports of a 4x4 Butler matrix with an offset beam

| Port number | 1 | 2 | 3 | 4 |
|---|---|---|---|---|
| Left most | 0° | −157.5° | 45° | −112.5° |
| beam | | | | |
| Second left | 0° | −67.5° | −135° | −202.5° |
| beam | | | | |
| Third left beam | 0° | 22.5° | 45° | 67.5° |
| Right most | 0° | 112.5° | 225° | 337.5° |
| beam | | | | |

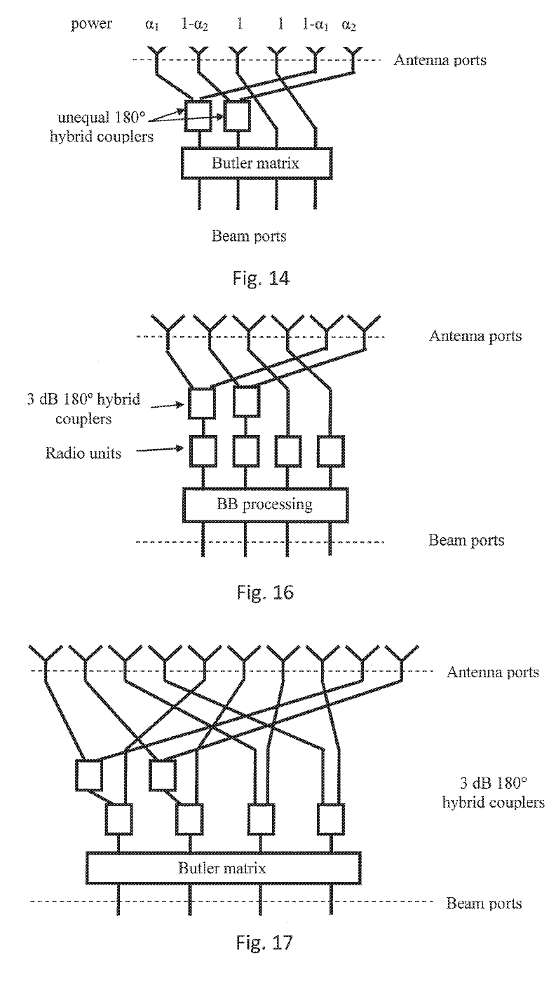

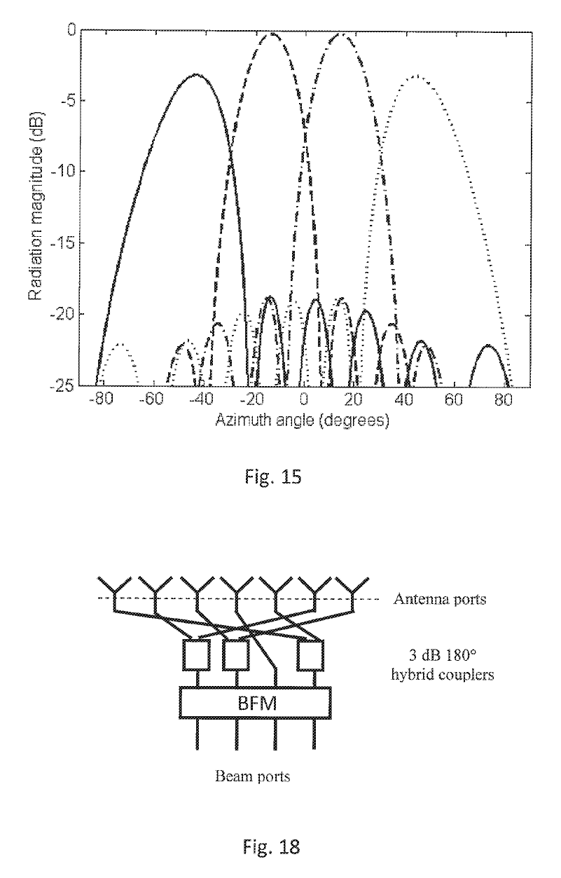

The above-described embodiments have all included identical splitter/combiners within an antenna arrangement 1. However, as mentioned previously the concept can be extended to include un-equal power splitter/combiner or hybrid couplers to further reduce the side-lobe level. An embodiment of this is shown in FIG. 14, where a 4×4 Butler matrix with unequal 180° hybrid couplers produces an element excitation with more freedom to choose the amplitude taper with maintained orthogonality between beams. Normalized radiation patterns of this embodiment are shown in FIG. 15. The peak side-lobe level has been further reduced to almost −19 dB. The power split of the unequal hybrid couplers is in this example α₁=α₂=0.36, but also other power split ratios of the hybrid couplers can be envisioned.

As mentioned previously, the generation of the fixed beams does not have to be done using a Butler matrix at RF but can equally well be performed at base band as illustrated in FIG. 16. However, the generated amplitude and phase distributions shall be the same as the ones generated by the Butler matrix. In this embodiment, a base-band processing matrix and radio units replace the above-described beam-forming matrix. Each antenna port has its own radio unit, and one or more splitter/combiners or hybrid couplers connect a subset of the respective radio units to one or more antenna elements.

With reference to FIG. 17, a further embodiment will be described. In this embodiment, two or more splitter/combiners 30 are connected in series or cascaded between an antenna port 21 and its connected antenna elements 10. Thereby, one antenna port 21 can be connected to more than two antenna elements 10 and even to an odd number of antenna elements. As before, the order and phase relation of the antenna ports needs to be maintained in the connected antennae. This embodiment enables further reduction of the side-lobe levels since the power to/from an antenna port is not only divided between two antenna elements but between three or more if two or more splitter/combiners 30 are cascaded.

In the previously described embodiments, the splitter/combiners 30 have been added at one or the other end of a beam-forming matrix 20. However, with reference to FIG. 18, it is equally possible to add one or more splitter/combiners 30 to the antenna ports 21 at one end of the beam-forming matrix 20 and at the same time add one or more splitter/combiners 30 to another end of the beam-forming matrix 20. In FIG. 18, splitter/combiners 30 have been added to the first, second and fourth antenna ports 21 of the beam-forming matrix. In this case the splitter/combiner 20 connected to the fourth antenna port 21 needs to be connected to the first an fifth antenna elements 10 in order to maintain the order and phase relation of the antenna ports 21. This could be described as a wrap around order. In other words, the order and periodicity of the antenna ports 21 is preserved in the order and periodicity of the antenna elements.

Another potential embodiment, however somewhat more complicated, of the proposed technology is to use the amplitude tapering in more than one dimension. In other words, consider the case where the antenna array is a planar antenna array where all antenna elements comprise columns of antenna elements. Consequently, a beam-forming matrix can comprise e.g. two subgroups of Butler matrixes, where the Butler matrixes of the first subgroup are connected to the antenna elements within each respective column of antenna elements and the Butler matrixes of the second subgroup are connected to the antenna elements within each respective row of antenna elements. Thereby the arrangement comprises e.g. a horizontally arranged subgroup of Butler matrixes and a vertically arranged subgroup of Butler matrixes. These can be arranged in any order between the beam ports and the antenna elements. Here one or more splitter/combiners or hybrid couplers can be connected between the serially connected Butler matrixes and the antenna elements.

With reference to FIG. 19, the embodiments of the antenna arrangement 1 described above can be provided as stand alone units connected to a network node 2 or included partly or as a whole in the network node 2 or arrangement in a wireless communication system.

The network node may also include radio circuitry for communication with one or more other nodes, including transmitting and/or receiving information.

It will be appreciated that the methods and devices described above can be combined and re-arranged in a variety of ways.

For example, embodiments may be implemented in hardware or in software for execution by suitable processing circuitry.

The steps, functions, procedures, and/or blocks described above may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits, ASICs.

Alternatively, at least some of the steps, functions, procedures, and/or blocks described above may be implemented in software such as a computer program for execution by suitable processing circuitry including one or more processing units. Examples of processing circuitry includes, but is not limited to, one or more microprocessors, one or more Digital Signal Processors, DSPs, one or more Central Processing Units, CPUs, video acceleration hardware, and/or any suitable programmable logic circuitry such as one or more Field Programmable Gate Arrays, FPGAs device or one or more Programmable Logic Controllers, PLCs.

It should also be understood that it might be possible to re-use the general processing capabilities of any conventional device or unit in which the proposed technology is implemented. It may also be possible to re-use existing software, e.g. by reprogramming of the existing software or by adding new software components.

Advantages of the embodiments of the proposed technology include the following
The side-lobe level of an array antenna fed with a Butler matrix can be reduced by adding a few antenna elements and identical power splitters/combiners
The directions of the multi beams are not altered
The beam-widths are reduced and the antenna gain is increased
All additional hardware is of same design, which reduces the complexity and costs
Number of additional antenna elements can vary
Applicable to interleaved dual polarized beam patterns

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

### REFERENCES

[1] A Fragola, M Orefice and M Pirola, “A modified Butler matrix for tapered excitation of scanned arrays”, IEEE International Symposium on Antennas and Propagation, Boston, Mass., pp. 784-787, 8-13 Jul. 2001.
[2] W-R Li, C-Y Chu, K-H Lin and S-F Chang, “Switched-beam antenna based on modified Butler matrix with low sidelobe level”, Electronics Letters, vol. 40, no. 5, pp. 290-292, March 2004
[3] K Wincza, S Gruszczynski and K Sachse, “Reduced sidelobe four-beam antenna array fed by modified Butler matrix”, Electronics Letters, vol. 42, no 9, pp. 508-509, April 2006

1. A multi beam antenna arrangement configured to generate a plurality of orthogonal antenna beams, the multi beam antenna arrangement comprising:
a plurality of antenna elements arranged to form an antenna array with a first end and an opposite second end; and
at least one beam-forming matrix having a plurality of antenna ports connected to said the antenna elements, the beam-forming matrix comprising:
at least two antenna ports with a predetermined order and phase relation and a plurality of beam ports, the at least two antenna ports being fewer in number than the plurality of antenna elements;
at least one of a subgroup of the least two antenna ports being connected to at least two of the plurality of antenna elements via at least one splitter/combiner arrangement to enable dividing a power supplied by the antenna port to the at least two antenna elements and combining a respective power received on the at least two antenna elements; and
antenna elements being positioned in the antenna array with a corresponding predetermined order and phase relation as the antenna ports to reduce side-lobe levels of the antenna arrangement while maintaining a linear phase gradient over the antenna elements.

2. The antenna arrangement according to claim 1, wherein the plurality of antenna elements are configured in a linear antenna array.

3. The antenna arrangement according to claim 1, wherein each of the plurality of antenna elements comprises a column of antenna elements, thereby forming a planar antenna array.

4. The antenna arrangement according to claim 2, wherein the plurality of antenna elements comprise dual polarized antenna elements, and the antenna arrangement further comprises two beam-forming matrices, each connected to a respective polarization of the dual polarized antenna elements via at least one respective power splitter/combiner.

5. The antenna arrangement according to claim 1, wherein the multi beam antenna arrangement comprises a plurality of identical splitter/combiner arrangements arranged at a plurality of the antenna ports.

6. The antenna arrangement according to claim 1, wherein the multi beam antenna arrangement comprises a plurality of non-identical splitter/combiner arrangements arranged at a plurality of the antenna ports.

7. The antenna arrangement according to claim 1, wherein the multi beam antenna arrangement comprises at least two power splitter/combiners connected in series between a same antenna port and a plurality of antenna elements.

8. The antenna arrangement according to claim 1, wherein the beam-forming matrix comprises one of a Butler matrix, a Blass matrix or a Rotman matrix, or a beam-forming matrix at the base band.

9. A network node comprising:
a multi beam antenna arrangement, the multi beam antenna arrangement configured to generate a plurality of orthogonal antenna beams, the multi beam antenna arrangement comprising:
a plurality of antenna elements arranged to form an antenna array with a first end and an opposite second end; and
at least one beam-forming matrix having a plurality of antenna ports connected to the antenna elements, the beam-forming matrix comprising:
at least two antenna ports with a predetermined order and phase relation and a plurality of beam ports, the at least two antenna ports being fewer in number than the plurality of antenna elements;
at least one of a subgroup of the least two antenna ports being connected to at least two of the plurality of antenna elements via at least one splitter/combiner arrangement to enable dividing a power supplied by the antenna port to the at least two antenna elements and combining a respective power received on the at least two antenna elements; and
the antenna elements being positioned in the antenna array with a corresponding predetermined order and phase relation as the antenna ports to reduce side-lobe levels of the antenna arrangement while maintaining a linear phase gradient over the antenna elements.

10. The network node according to claim 9, wherein the plurality of antenna elements are configured in a linear antenna array.

11. The network node according to claim 9, wherein each of the plurality of antenna elements comprises a column of antenna elements, thereby forming a planar antenna array.

12. The network node according to claim 10, wherein the plurality of antenna elements comprise dual polarized antenna elements, and the antenna arrangement further comprises two beam-forming matrices, each connected to a respective polarization of the dual polarized antenna elements via at least one respective power splitter/combiner.

13. The network node according to claim 9, wherein the multi beam antenna arrangement comprises a plurality of identical splitter/combiner arrangements arranged at a plurality of the antenna ports.

14. The network node according to claim 9, wherein the multi beam antenna arrangement comprises a plurality of non-identical splitter/combiner arrangements arranged at a plurality of the antenna ports.

15. The network node according to claim 9, wherein the multi beam antenna arrangement comprises at least two power splitter/combiners connected in series between a same antenna port and a plurality of antenna elements.

16. The network node according to claim 9, wherein the beam-forming matrix comprises one of a Butler matrix, a Blass matrix or a Rotman matrix, or a beam-forming matrix at the base band.

17. The antenna arrangement according to claim 3, wherein the plurality of antenna elements comprise dual polarized antenna elements, and the antenna arrangement further comprises two beam-forming matrices, each connected to a respective polarization of the dual polarized antenna elements via at least one respective power splitter/combiner.

18. The antenna arrangement according to claim 2, wherein the multi beam antenna arrangement comprises a plurality of identical splitter/combiner arrangements arranged at a plurality of the antenna ports.

19. The antenna arrangement according to claim 2, wherein the multi beam antenna arrangement comprises a plurality of non-identical splitter/combiner arrangements arranged at a plurality of the antenna ports.

20. The antenna arrangement according to claim 2, wherein the multi beam antenna arrangement comprises at least two power splitter/combiners connected in series between a same antenna port and a plurality of antenna elements.
